(19) United States
(12) Patent Application Publication
(10) Pub. No.: US 2017/0050117 A1
(43) Pub. Date: Feb. 23, 2017

(54) Companion Doll

(71) Applicant: Rosemarie Guiliano, Brooklyn, NY (US)

(72) Inventor: Rosemarie Guiliano, Brooklyn, NY (US)

(21) Appl. No.: 15/243,833

(22) Filed: Aug. 22, 2016

Related U.S. Application Data
(60) Provisional application No. 62/208,047, filed on Aug. 21, 2015.

(51) Int. Cl. A63H 3/00; A63H 3/28; G09B 19/00

(52) U.S. Cl. CPC A63H 3/003; G09B 19/00; A63H 3/28

(57) ABSTRACT

A companion doll device for providing encouragement and enthusiasm to overcome life obstacles is provided. The companion doll device comprises a doll and an integrated audio player mounted within the doll. The integrated audio player selectively emits positive motivational messages. The doll instills courage to accomplish goals and follow dreams thereby providing a sense of hope and positivity carried into all aspects of life.

### CLAIM OF PRIORITY

This patent application claims priority under 35 USC 119 (e) (1) from U.S. Provisional Patent Application Ser. No. 62/208,047 filed Aug. 21, 2015, of common inventorship herewith entitled, “2 BU Doll Line,” which is incorporated herein by reference as though the same were set forth in its entirety.

### FIELD OF THE INVENTION

The present invention pertains to the field of collectible dolls, and more specifically to the field of companion dolls.

### BACKGROUND OF THE INVENTION

Finding one's true path in life and maintaining a positive outlook sometimes is difficult, particularly in today's ever changing world. This is especially true for children and teens who are inundated with influential forces that can often have a negative impact. From peer pressure to putting oneself in risky situations to negative comments and graphic images sent out over social media to violent video games, movies and, television programs that seemingly promote disrespect, anger and sex, children are literally bombarded with sights, sounds and images that can cause them to doubt themselves and their worthiness and lead them to follow a dangerous path.

With so much pressure and negativity impacting children at increasingly younger ages, it often is difficult for youngsters to find regular encouragement that promotes positive thinking. Even those children who grow up in safe and loving homes with supportive family and friends can suffer stress and doubt while nonetheless living a happy life. For those children and teens who lack a firm foundation of family or community support, this problem is even more challenging. Most experts agree that during times of hardship when pressure is intense, when people are failed by loved ones or when odds seem insurmountable, a simple word of encouragement or inspiration can help put events in perspective and enable that person to make it through hard times.

The prior art has put forth several designs for companion dolls. Among these are:

U.S. Pat. No. 7,186,212 to Matthew McMullen describes a full-size, fully articulated doll possessing visual and postural verisimilitude with that of an adult human female with selectively displayed alternative faces by an exchange of face masks or heads. Articulation is provided by an internal skeleton having movable joints between rigid members. A flexible resilient material inclusive of silicone rubber is used for simulated skin inclusive of the faces. A rigid moldable material inclusive of epoxy is used for a simulated skull possessing a movable jaw that is displaceable mechanically. An audio device is added to provide aural verisimilitude in conjunction with the movable jaw and artificial eyeballs which also are displaceable mechanically. A moderately soft resilient material inclusive of polyurethane foam is used for simulated flesh. Alternatively selected faces enable variation of appearance inclusive of both expression and genotype.

U.S. Pat. 7,435,153 to John Sodec, Jr., describes a companion doll for use in a patrol car to give the illusion of the presence of an additional officer or for home companion use. The doll has a human like appearance and has several components that articulate including a head that turns, upper and lower arms that raise and lower, and hands that open and close. Motion of these components are random or can be in response to received external stimuli wherein the doll uses motion and light sensors to detect this stimuli. A closed loop heated water pumping system within the doll warms exterior surface of the doll to give the doll further human like qualities.

US Patent Publication 2005/0027162 to Steve Paled describes a life-size human doll that is preferably formed from a composite of silicone and polyurethane. Silicone is utilized in sensitive regions including the face, genital area, anal area and breast area. It is preferred that the human doll be anatomically correct. It is further preferred to provide the human doll with a heartbeat simulator and a high quality sound production system capable of producing voice type sounds. The sounds are preferably downloadable from a network in a plurality of languages.

None of these prior art references describe the present invention.

### SUMMARY OF THE INVENTION

It is an object of the present invention to provide a striking and stylish line of companion dolls with each doll having an integrated audio player for emitting positive motivational messages.

The present invention is a companion doll device for providing encouragement and enthusiasm to overcome life obstacles. The companion doll device comprises a doll and an integrated audio player mounted within the doll. The integrated audio player selectively emits positive motivational messages. The doll instills courage to accomplish goals and follow dreams thereby providing a sense of hope and positivity carried into all aspects of life.

In addition, the present invention includes a method for providing encouragement and enthusiasm to overcome life obstacles. The method comprises providing a doll, mounting an integrated audio player mounted within the doll, emitting positive motivational messages from the integrated audio player, instilling courage to accomplish goals and follow dreams, and providing a sense of hope and positivity carried into all aspects of life.

The present invention further includes a companion doll device for providing encouragement and enthusiasm to overcome life obstacles. The companion doll device comprises a resilient doll having moveable appendages. The doll is lifelike in appearance and appropriately proportioned and scaled to resemble the body of a young person. An accessory is positionable on the doll with the accessory having an inscription with an inspirational name of the doll. An integrated audio player is mounted within the doll with the integrated audio player selectively emitting positive motivational messages. The doll instills courage to accomplish goals and follow dreams thereby providing a sense of hope and positivity carried into all aspects of life.

### BRIEF DESCRIPTION OF THE DRAWINGS

FIG. 1 is a front perspective view illustrating a companion doll, constructed in accordance with the present invention, showing a soft textured doll facsimile of an attractive and smiling young lady with flexible arms.

FIG. 2 is a rear perspective view illustrating the companion doll, constructed in accordance with the present invention, showing a soft textured doll facsimile of the attractive and smiling young lady with flexible arms.

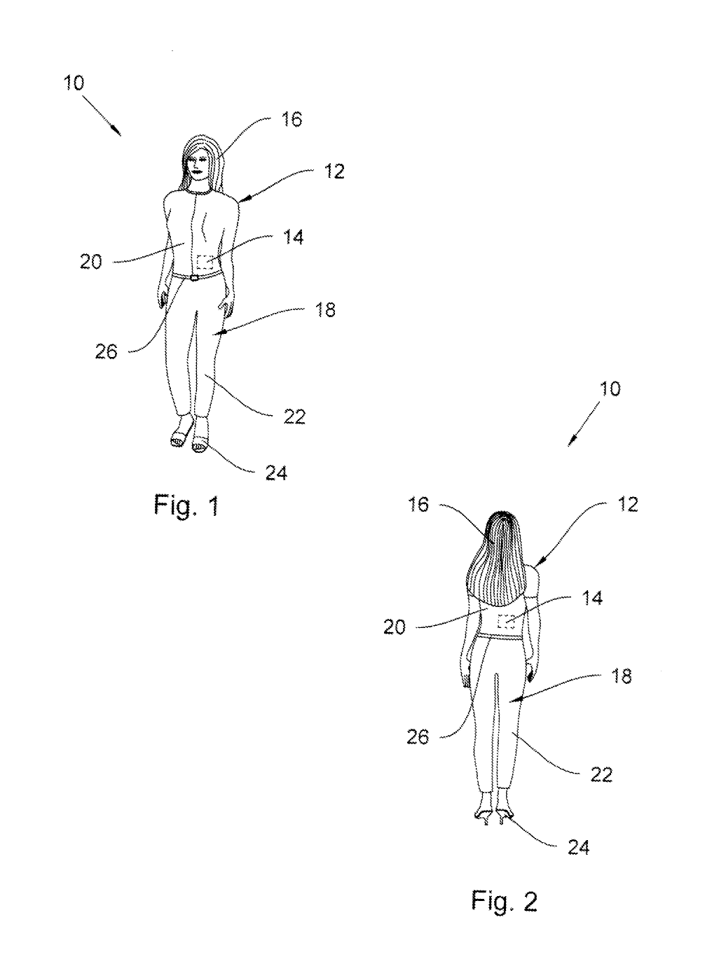

### DETAILED DESCRIPTION OF THE INVENTION

The present invention, hereinafter referred to as a Companion Doll Device, indicated generally at 10, is a striking and stylish line of dolls 12 with each doll 12 having an integrated audio player 14 which emits positive motivational messages. The doll 12 of the Companion Doll Device 10 of the present invention provides individuals of all ages, particularly children and teens, with a contemporary collectible doll 12 that provides encouragement and enthusiasm to overcome obstacles in life. The doll 12 functions in an inspirational role as a lasting friend and charming keepsake. Basically, the Companion Doll Device 10 is a line of realistically rendered and stylish dolls 12, with each doll 12 developed to provide a constant and reliable source of encouragement and positivity to their human owner.

The doll 12 of the Companion Doll Device 10 of the present invention preferably measures approximately thirteen (13″) inches to approximately fifteen (15″) inches in total length. Lifelike in appearance and appropriately proportioned and scaled to resemble the body of a young person, each doll 12 is manufactured primarily of molded plastic, vinyl or synthetic material and contains moveable appendages. The body of the doll 12 is firm enough to maintain its shape, yet soft and huggable to provide tactile comfort to the human owner. The dolls 12 are constructed in facsimiles of striking young females and males of various ethnicities including Hispanic, Asian, African American, and Caucasian. Emanating positivity and confidence, each doll 12 has large friendly eyes, a smiling mouth and other facial features that are realistically human but also evoke the charming whimsy of a doll. The doll 12 can have long flowing hair 16 in a variety of shades such as brunette, blonde, auburn, or black as well as in various textures including straight, curly or braided. Preferably, the doll of the Companion Doll Device 10 is dressed in contemporary clothing 18 that reflects today's styles and fashion trends.

Each doll 12 of the Companion Doll Device 10 of the present invention is initially dressed in an elegant and stylish shirt 20 and coordinating dress pants 22 with socks and shoes 24 included in the ensemble. Optional ensembles and accessories for the Companion Doll Device 10 are available separately. Each doll 12 includes a lovely bracelet, pretty necklace, or handsome belt 26 inscribed with an inspirational name of the doll 12.

Most notably the dolls 12 of the Companion Doll Device 10 of the present invention preferably include an integrated audio player 14 which emits positive messages of encouragement to the user. Powered with standard AA or AAA batteries, the audio player 14 is housed in the body of the doll 12 and is activated by squeezing the hand or tummy of the doll 12. The doll 12 delivers the messages in a calm and soothing voice that foster comfort in all who hear. Messages include such sentiments as “Hi! I am your inspirational angel”, “I will give you the strength to be strong and positive”, and “I will protect you and will and can get through anything!” The doll 12 may also say comforting words such as “Have no fears, I will be right by your side and am with you at all times”. These verbal messages reassure the child that they have a friend who will be there for them always.

An alternate embodiment of the Companion Doll Device 10 of the present invention is a line of cartoon character dolls who address relevant issues as divorce, bullying, drugs, peer pressure and homosexuality. All embodiments of the Companion Doll Device 10 provide a simple way of offering positivity and encouragement to children and teenagers. A lifelike doll 12 that addresses a child's fears and self-doubt, the doll comforts and supports the child when times are difficult or the child simply needs a friendly face. Providing a source of constant support and a loyal friend, the doll 12 is used to encourage the child to keep their focus, strive to do their best and ensure them that good things await them on the horizon.

With the doll of the Companion Doll Device 10 by their side, a child finds courage within themselves to accomplish their goals and follow their dreams. In this manner, the doll 12 instills a sense of hope and positivity in the child that is carried into all aspects of their life. A powerful support system, the doll 12 functions as a guardian angel of sorts, never leaving the child's side. With stylish clothing and accessories, children relate to the doll 12 while also enjoying endless scenarios for creative play. A fully functioning toy, the Companion Doll Device 10 provides younger children with hours of fun and older children and teenagers with a fun and motivating companion.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A companion doll device for providing encouragement and enthusiasm to overcome life obstacles, the companion doll device comprising:
a doll; and
an integrated audio player mounted within the doll, the integrated audio player selectively emitting positive motivational messages;
wherein the doll instills courage to accomplish goals and follow dreams thereby providing a sense of hope and positivity carried into all aspects of life.

2. The companion doll device of claim 1 wherein the doll is lifelike in appearance and appropriately proportioned and scaled to resemble the body of a young person.

3. The companion doll device of claim 1 wherein the doll is constructed from a material selected from the group consisting of molded plastic, vinyl, and synthetic material.

4. The companion doll device of claim 1 wherein the doll has moveable appendages.

5. The companion doll device of claim 1 wherein the doll is resilient to maintain its shape.

6. The companion doll device of claim 1 wherein the doll is constructed of various ethnicities including Hispanic, Asian, African American, and Caucasian.

7. The companion doll device of claim 1 wherein the doll has hair in a variety of shades including brunette, blonde, auburn, and black, the hair being in a variety of textures including straight, curly, and braided.

8. The companion doll device of claim 1 and further comprising:
contemporary clothing reflecting current styles and fashion trends.

9. The companion doll device of claim 1 and further comprising:
an accessory positionable on the doll, the accessory having an inscription with an inspirational name of the doll.

10. The companion doll device of claim 1 wherein the integrated audio player is activated by pressing a preselected portion of the doll.

11. The companion doll device of claim 10 wherein the preselected portion is a hand or a stomach.

12. The companion doll device of claim 1 wherein positive motivational messages are delivered in a calm and soothing voice that fosters comfort.

13. The companion doll device of claim 12 wherein the messages are selected from the group consisting of “Hi! I am your inspirational angel”, “I will give you the strength to be strong and positive”, “I will protect you and will and can get through anything!”, and “Have no fears, I will be right by your side and am with you at all times”.

14. The companion doll device of claim 1 wherein the doll is a cartoon character who address relevant issues as divorce, bullying, drugs, peer pressure, and homosexuality.

15. A method for providing encouragement and enthusiasm to overcome life obstacles, the method comprising:
providing a doll;
mounting an integrated audio player mounted within the doll;
emitting positive motivational messages from the integrated audio player;
instilling courage to accomplish goals and follow dreams; and
providing a sense of hope and positivity carried into all aspects of life.

16. A companion doll device for providing encouragement and enthusiasm to overcome life obstacles, the companion doll device comprising:
a resilient doll having moveable appendages, the doll being lifelike in appearance and appropriately proportioned and scaled to resemble the body of a young person;
an accessory positionable on the doll, the accessory having an inscription with an inspirational name of the doll; and
an integrated audio player mounted within the doll, the integrated audio player selectively emitting positive motivational messages;
wherein the doll instills courage to accomplish goals and follow dreams thereby providing a sense of hope and positivity carried into all aspects of life.

17. The companion doll device of claim 16 wherein the doll is constructed of various ethnicities including Hispanic, Asian, African American, and Caucasian.

18. The companion doll device of claim 16 wherein the doll has hair in a variety of shades including brunette, blonde, auburn, and black, the hair being in a variety of textures including straight, curly, and braided.

19. The companion doll device of claim 16 wherein the integrated audio player is activated by pressing a preselected portion of the doll.

20. The companion doll device of claim 16 wherein positive motivational messages are delivered in a calm and soothing voice that fosters comfort.
